(19) United States
(12) Patent Application Publication
(10) Pub. No.: US 2013/0073840 A1
(43) Pub. Date: Mar. 21, 2013

(54) APPARATUS AND METHOD FOR GENERATING AND MANAGING AN ENCRYPTION KEY

(71) Applicant: Kwang Baek KIM, Seoul (KR)

(72) Inventor: Kwang Baek KIM, Seoul (KR)

(73) Assignee: PANTECH CO., LTD., Seoul (KR)

(21) Appl. No.: 13/442,368

(22) Filed: Apr. 9, 2012

(30) Foreign Application Priority Data
Sep. 21, 2011 (KR) 10-2011-0094996

(51) Int. Cl. G06F 21/00; G06F 9/00

(52) U.S. Cl. 713/2; 713/189

(57) ABSTRACT

A portable terminal, includes: a first hardware module to encrypt data using an encryption key; a communication module to receive the encryption key, wherein the communication module receives the encryption key if the portable terminal is in a secure mode. A method includes: entering a secure mode of the portable terminal; receiving an encryption key; forwarding the encryption key to a first hardware module, wherein the first hardware module encrypts data with the encryption key. An apparatus, includes: a booting unit to enter into a secure mode; a first hardware module to receive an encryption key to encrypt data; and a second hardware module to receive the encrypted data, and the second hardware module being disabled in the secure mode, wherein the first hardware module receives the encryption at a fixed location of the apparatus.

### CROSS-REFERENCE TO RELATED APPLICATION

This application claims priority from and the benefit under 35 U.S.C. §119(a) Korean Patent Application No. 10-2011-0094996, filed on Sep. 21, 2011, which is hereby incorporated by reference for all purposes as if fully set forth herein.

### BACKGROUND

1. Field

Exemplary embodiments of the present invention relate to an apparatus and a method for generating and managing an encryption key of a portable terminal

2. Discussion of the Background

Applications that utilize a security measure, for example a login or certificate key, such as financial programs may be implemented on various electronic devices, such as a smart phone, a tablet personal computer (PC), and the like. However, the applications may be vulnerable to a security compromise of the electronic device that the application is implemented on. For example, if the electronic device uses an open source operating system (OS), it may be even further vulnerable to having the device's security compromised.

A secure method using a virtual keyboard provided on a web server may be used.

However, the secure method using the virtual keyboard may access a web server and thus, be vulnerable to a security compromise while accessing the web server.

Thus, data transmitted between hardware modules within a portable terminal may not be effectively protected. Also, an encryption key to encrypt data transmitted between hardware modules within the portable terminal may not be effectively protected.

### SUMMARY

Exemplary embodiments of the present invention provide an apparatus and method for generating and managing an encryption key in a secure method, to allow multiple portable hardware modules of a single or multiple devices to communicate each other in a manner to prevent a security compromise.

Additional features of the invention will be set forth in the description which follows, and in part will be apparent from the description, or may be learned by practice of the invention.

An exemplary embodiment of the present invention discloses a portable terminal, including: a first hardware module to encrypt data using an encryption key; a communication module to receive the encryption key, wherein the communication module receives the encryption key if the portable terminal is in a secure mode.

An exemplary embodiment of the present invention discloses a method for implementing an encryption key on a portable terminal, including: entering a secure mode of the portable terminal; receiving an encryption key; forwarding the encryption key to a first hardware module, wherein the first hardware module encrypts data with the encryption key

An exemplary embodiment of the present invention discloses an apparatus, including: a booting unit to enter into a secure mode; a first hardware module to receive an encryption key to encrypt data; and a second hardware module to receive the encrypted data, and the second hardware module being disabled in the secure mode, wherein the first hardware module receives the encryption at a fixed location of the apparatus.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a portable terminal according to an exemplary embodiment of the present invention.

FIG. 2 is a block diagram illustrating a configuration of a portable terminal according to an exemplary embodiment of the present invention.

FIG. 3 is a block diagram illustrating a configuration of a portable terminal according to an exemplary embodiment of the present invention.

FIG. 4 is a flowchart illustrating a method for generating and managing an encryption key of a portable terminal according to an exemplary embodiment of the present invention.

FIG. 5 is a flowchart illustrating a method for generating and managing an encryption key of a portable terminal according to an exemplary embodiment of the present invention.

FIG. 6 is a flowchart illustrating a method for receiving a secure key from an authentication server according to an exemplary embodiment of the present invention.

FIG. 7 is a flowchart illustrating a method of generating and managing an encryption key of a portable terminal according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify s the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

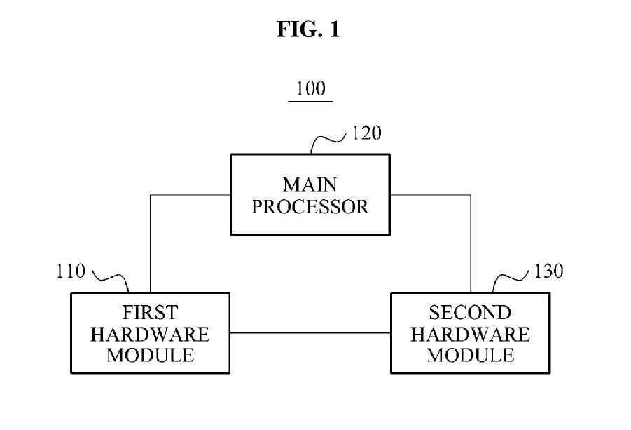

FIG. 1 is a block diagram illustrating a portable terminal according to an exemplary embodiment of the present invention.

Referring to FIG. 1, a portable terminal 100 includes a first hardware module 110, a main processor 120, and a second hardware module 130.

Data transmitted and received between the first hardware module 110 and the second hardware module 130 may be encrypted using a secure key. For example, the first hardware module 110 may encrypt data to be transmitted to the second hardware module 130 using the secure key, and may transmit the encrypted data to the second hardware module 130. A secure key may refer to an encryption key used for an encryption algorithm.

The first hardware module 110 may encrypt data transmitted to the second hardware module 130 using a first key, and the second hardware module 130 may decrypt the data encrypted by the first key using a second key. Here, the first key and the second key may have a pair relationship. The pair relationship may indicate a case where the first key and the second key have the same key value, a symmetric key relationship, or asymmetric key relationship. A symmetric relationship and an asymmetric relationship may refer to how the pair of keys relate to each other. Accordingly, the first key may be a key used to encrypt data, and the second key may be a key used to decrypt the data that is encrypted using the first key.

A portable terminal may refer to a plurality of hardware modules. For example, the portable terminal 100 may further include an input or an output module, such as a touch panel.

Also, the portable terminal 100 may further include a touch integrated circuit (IC) connected to the touch panel to detect an electrical signal received from the touch panel. Here, a program implementing various types of encryption algorithms may be embedded in the touch IC. Therefore, using the secure key, the touch IC may encrypt coordinate information input via the touch panel, and the like.

The portable terminal 100 may include a communication module. The communication module may include at least one circuit element to perform communication: such as, Global System for Mobile Communications (GSM), Enhanced Data GSM Environment (EDGE), wideband code division multiple access (W-CDMA), code division multiple access (CDMA), time division multiple access (TDMA), Bluetooth, Institute of Electrical and Electronics Engineers (IEEE) 802.11a, IEEE 802.11b, IEEE 802.11g, IEEE 802.11n, and the like, Wireless Fidelity (Wi-Fi), voice over Internet Protocol (VoIP), Wi-MAX, Long Term Evolution (LTE), radio frequency identification (RFID), Near Field Communication (NFC), and the like.

A hardware module may refer to a module that receives a user input. The hardware module may also refer to a communication module that receives data through a communication technique. A hardware module may include an IC to perform an encryption algorithm. This encryption algorithm may be used to generate either the first or second key.

For example, the first hardware module 110 or the second hardware module 130 may be any one of an input or an output module, a communication module, a universal subscriber identity module (USIM), a display module, or the like.

The main processor 120, the first hardware module 110 or the second hardware module 130 may generate, transmit, receive, distribute, and manage one or more secure keys.

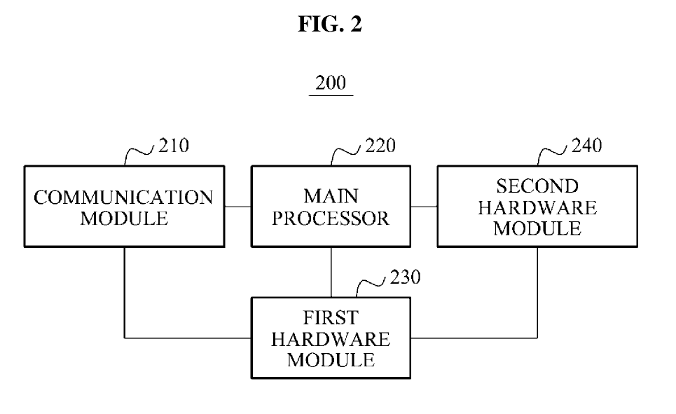

FIG. 2 is a block diagram illustrating a configuration of a portable terminal according to an exemplary embodiment of the present invention.

Referring to FIG. 2, the portable terminal 200 may include a communication module 210, a main processor 220, a first hardware module 230, and a second hardware module 240.

The communication module 210 may access an authentication server over a network, and receive a secure key from the authentication server. The authentication server receives a request to encrypt an object, and transmits the encrypted object. For example, a server of a financial company or a server of a communication provider may be the authentication server. Also, the authentication server may be a separate server used to authenticate a user.

The main processor 220 may forward, to the first hardware module 230, the secure key that is received from the authentication server. The main processor 220 may also forward the secure key to the second hardware module 240. That is, the main processor 220 may distribute the secure key to one or more hardware modules that perform encryption or decryption. For example, the main processor 220 may also forward the secure key to the communication module 210.

The main processor 220 may forward the received secure key to at least one of the hardware modules based on a user setting. For example, the main processor 220 may automatically forward the secure key to at least one of an input or an output module, a communication module, a USIM, and a display module.

Also, the main processor 220 may forward the secure key to a hardware module designated by a user. For example, the hardware module designated by the user may be a USIM, or any of the above-listed types of hardware modules.

If a secure mode enter signal is received, the main processor 220 may allow the portable terminal 200 to enter into a secure mode (such as through a reboot process, however not limited to), and may authenticate the user in the secure mode. Here, the secure mode enter signal may be a signal input provided by the user, or a signal input generated from another source. The secure mode may provide some security with respect to user input data, or an operational mode utilizing data transmitted and received between various hardware modules, with the data being encrypted in the secure mode.

The secure key received from the authentication server may include a first key used to encrypt data and a second key used to decrypt the data that is encrypted using the first key. The first key may be forwarded to the first hardware module 230, and the second key may be forwarded to the second hardware module 240.

The first hardware module 230 may encrypt data using the secure key and may transmit the encrypted data to the second hardware module 240 or the communication module 210.

The first hardware module 230 may be removable from the portable terminal 200. For example, the first hardware module 230 may be a USIM, or the like.

The second hardware module 240 may decrypt the encrypted data using the secure key. Also, the second hardware module 240 may also transmit the encrypted data to another portable terminal using the communication module 210. Even though the second hardware module 240 is shown separately in FIG. 2, the second hardware module 240 may be implemented as the communication module 210.

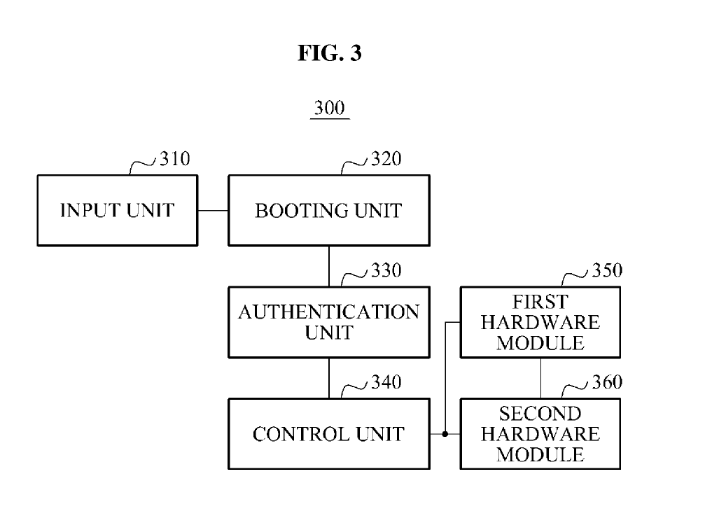

FIG. 3 is a block diagram illustrating a configuration of a portable terminal according to an exemplary embodiment of the present invention.

Referring to FIG. 3, the portable terminal 300 may include an input unit 310, a booting unit 320, an authentication unit 330, a control unit 340, a first hardware module 350, and a second hardware module 360.

The input unit 310 may receive a secure mode enter signal from a user, and provide the user with an input interface to input a secure key. The input interface may enable the user to input at least one of a number, a character, a special symbol, and the like.

The input unit 310 may include a touch panel. Also, the input unit 310 may include at least one of a mechanical button or switch, a voice input device, a motion detecting sensor, and the like. The secure mode enter signal may be generated in response to a motion of the portable terminal 300, a voice input of the user, or a manipulation of the mechanical switch.

The booting unit 320 may reboot the portable terminal 300 using a system image stored in a memory. Here, the system image may be stored in a portion of a memory which may be inaccessible or non-writeable by the user. For example, during the manufacture of the portable terminal 300, a manufacturer may store the system image in a portion of the memory inaccessible or non-writeable by the user. Here, the system image may include files used to configure a terminal to perform a minimum, or specific, number of tasks. For example, the system image may be a kernel image or a boot-loader of a Linux system. The addition of a system image may be any sort of computer implemented technique for rebooting a portable terminal in a secure mode.

The authentication unit 330 may authenticate the user in the secure mode. For example, in a state where the portable terminal 300 is rebooted in the secure mode, the authentication unit 330 may authenticate the user by comparing a user provided or inputted password with a reference password.

The control unit 340 may forward the inputted secure key to the first hardware module 350. The secure key may be data that is inputted by the user via the input interface. For example, the control unit 340 may use, as the secure key, at least one of numbers, characters, symbols, and the like.

The control unit 340 may forward the secure key to the second hardware module 360. For example, the control unit 340 may distribute the secure key to all, or some, of the hardware modules that perform encryption or decryption. Even though the booting unit 320, the authentication unit 330, and the control unit 340 are separately illustrated in FIG. 3, the booting unit 320, the authentication unit 330, and the control unit 340 may be configured as a single processor.

The first hardware module 350 may encrypt data using the secure key, and may transmit the encrypted data to the second hardware module 360.

The second hardware module 360 may decrypt the encrypted data using the secure key.

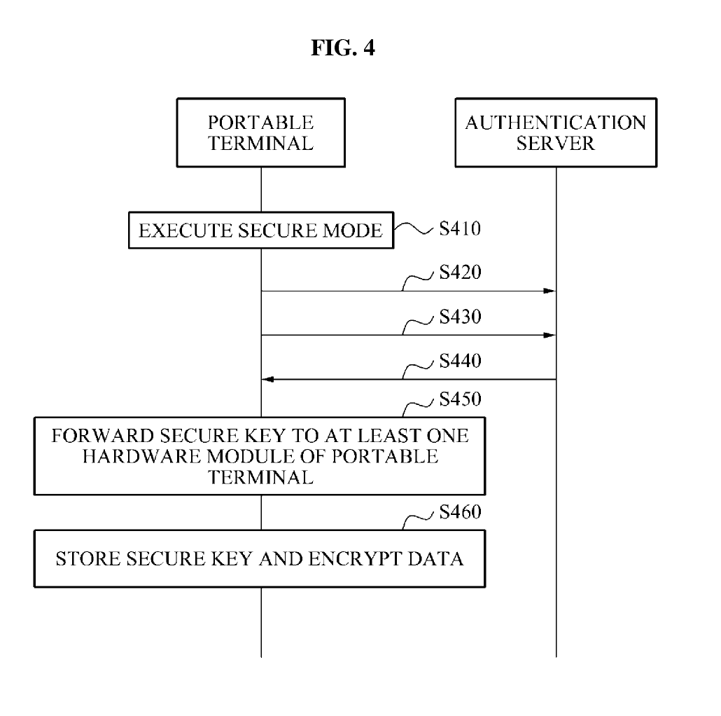

FIG. 4 is a flowchart illustrating a method for generating and managing an encryption key of a portable terminal according to an exemplary embodiment of the present invention.

Referring to FIG. 4, in operation S430, a portable terminal may access an authentication server. The portable terminal may execute a secure mode in operation S410. For example, in operation S410, the portable terminal may receive a signal to enter a secure mode, rebooted in a secure mode, and authenticate a user in the secure mode.

Also, in operation S420, the portable terminal may register user information of the portable terminal to the authentication server.

The user information may include at least one of: an international mobile subscriber identify (IMSI) of a USIM, a media access control (MAC) address of a communication module, an international mobile equipment identify (IMEI) of the portable terminal, a telephone number of the portable terminal, a user identification (ID), a password, and a serial number of the portable terminal.

The user information registered to the authentication server may further include information about a hardware module to store the secure key.

The authentication server may generate the secure key based on the user information received from the portable terminal. For example, the authentication server may generate the secure key by multiplying user information with random numbers, or by converting the user information to a binary code. Also, the authentication server may transmit a reference secure key to the portable terminal.

If the user information received from a user terminal is present in a database, and a user ID does not match the user information, the authentication server may bypass the generation of the secure key. Also, if the user ID is valid and the IMSI of the USIM is different than pre-stored information, the authentication server may update the IMSI stored in the database.

In operation S440, the portable terminal may receive the secure key from the authentication server.

In operation S450, the portable terminal may forward the secure key to at least one hardware module of the portable terminal. The secure key may be used to encrypt data transmitted between a first hardware module and a second hardware module of the portable terminal. The secure key may include a first key used to encrypt data and a second key used to decrypt data that is encrypted using the first key. The first key may be forwarded to the first hardware module, and the second key may be forwarded to the second hardware module.

In operation S460, at least one hardware module receiving the secure key may store the secure key, and may encrypt data using the secure key.

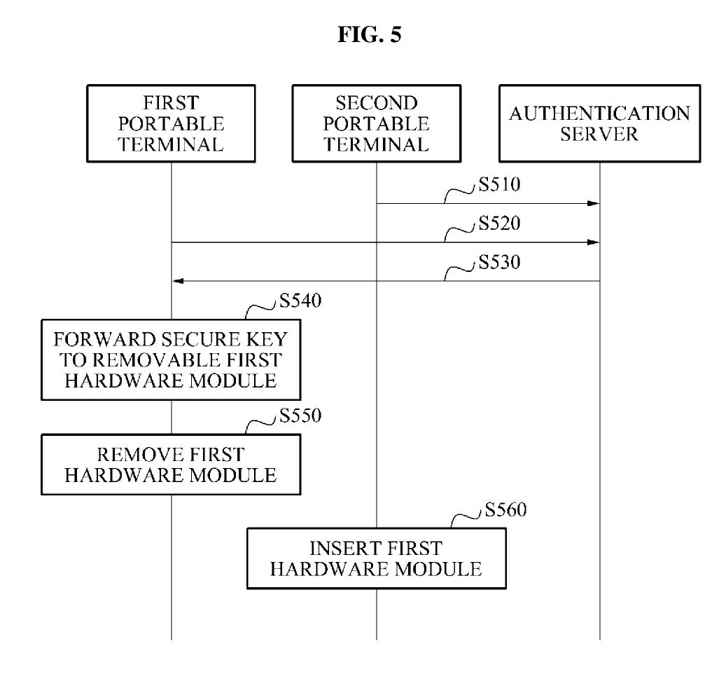

FIG. 5 is a flowchart illustrating a method for generating and managing an encryption key of a portable terminal according to an exemplary embodiment of the present invention.

Referring to FIG. 5, removable hardware module that manages a secure key may be implemented. The removable hardware module may be a USIM or the like. The removable hardware module may refer to a first hardware module. The first hardware module may be inserted into a first portable terminal and a second portable terminal.

Referring to FIG. 5, in operation S510, the second portable terminal may register user information of the portable terminal to an authentication server. For example, a user may register user information to the authentication server using the second portable terminal. The second portable terminal may be a portable terminal owned or controlled by the user. After operation S510, the first hardware module may be inserted into the first portable terminal.

In operation S520, the first portable terminal may access the authentication server. A user ID and a password to access the authentication server may be the user ID and password used in operation S510. The first portable terminal may be a secured portable terminal. For example, the first portable terminal may have a greater security capability versus the second portable terminal. Also, the first portable terminal may be located in a specific location designated to receive a secure key, such as a service center of a communication provider.

In operation S530, the first portable terminal may receive the secure key from the authentication server. For example, the authentication server may transmit, to the first portable terminal, a secure key stored in a database or a newly generated secure key.

In operation S540, the first portable terminal may forward the received secure key to the removable first hardware module. The secure key stored in the first hardware module may be used to encrypt data transmitted between the first hardware module and a second hardware module of the second portable terminal.

In operation S550, the first hardware module may be removed from the first portable terminal. In operation S560, the first hardware module may be inserted into the second portable terminal.

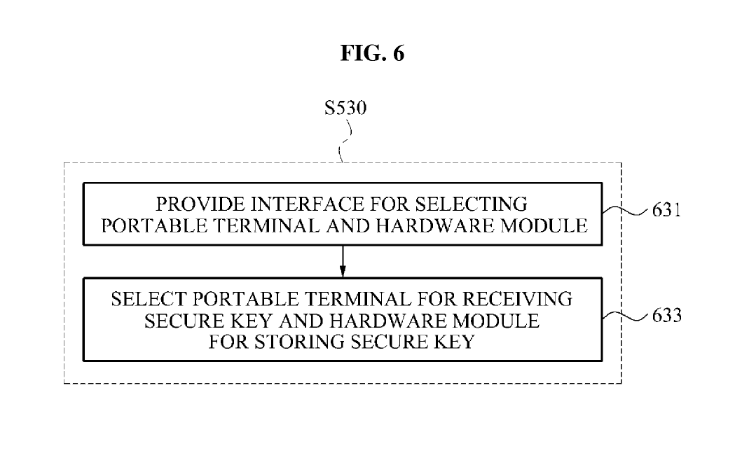

FIG. 6 is a flowchart illustrating a method for receiving a secure key from an authentication server according to an exemplary embodiment of the present invention.

Referring to FIG. 6, in operation 631, the first portable terminal may receive, from the authentication server, an interface used to select a portable terminal and a hardware module. For example, if a plurality of portable terminals is registered to the authentication server, the authentication server may display a list of the portable terminals. Through operation 631, if the plurality of portable terminals is registered to the authentication terminal, a terminal to be used with the secure key may be selected. The secure key may be used in the second portable terminal.

In operation 633, a user or an operation of the first portable terminal may select a portable terminal to receive the secure key and a hardware module to store the secure key, via the interface.

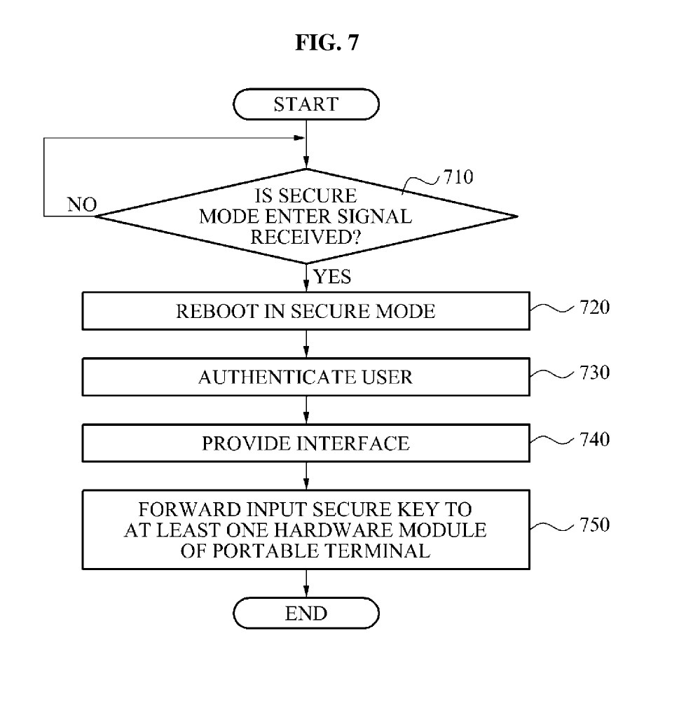

FIG. 7 is a flowchart illustrating a method for generating and managing an encryption key of a portable terminal according to an exemplary embodiment of the present invention.

In a booting state, a portable terminal may be vulnerable to a security compromise. Thus, a secure key may be generated by rebooting the portable terminal in a secure mode. In an example, the secure key may be generated in a non-booting state, in which the portable terminal may be less vulnerable to a security compromise.

Referring to FIG. 7, in operation 710, the portable terminal may determine whether a signal to enter secure mode is received. If the secure mode enter signal is received, the portable terminal may reboot in the secure mode using a system image stored in a memory. The system image may be stored in the memory at a portion inaccessible or not writeable by a user. For example, during the manufacture of the portable terminal, the manufacturer may store the system image in the memory in a way to ensure that the system image is inaccessible or not writeable by the user, or another denoted operation accessing the system image. Here, the system image may indicate files to boot a terminal to perform one or more number of tasks. For example, the system image may be, without limitation, a kernel image or a bootloader of Linux system. Also, a minimum, or specific, number of drivers associated with the kernel to perform basic operations of the portable terminal may be included in the system image. In the case of rebooting, the portable terminal may determine whether the system image is changed and the like, by using checksum data. A checksum may be a type of redundancy check that is used to detect errors in data. For example, the portable terminal may determine whether the system image is changed by comparing a portion of information of the system image with reference information.

In operation 730, the portable terminal may authenticate the user in the secure mode. For example, the portable terminal may receive a password and may authenticate the user by comparing the received password with a reference password. If initial rebooting is performed in the secure mode, the portable terminal may perform a process of setting the password.

In operation 740, the portable terminal may provide the user with an input interface to input the secure key. The input interface may indicate an interface of enabling the user to input at least one of a number, a character, a special symbol, and the like. The secure key may be inputted using a sound signal. For example, the portable terminal may analyze a sound signal of the user, convert an electrical pattern of the sound signal to characters, and use the converted characters as the secure key. Instead of directly receiving the secure key from the user, if the portable terminal is rebooted in the secure mode, the portable terminal may automatically generate the secure key and may store the generated secure key in a hardware module.

In operation 750, the portable terminal may forward the input secure key to at least one hardware module of the portable terminal. Here, the portable terminal may generate the secure key using data inputted via the input interface, and may forward the generated secure key to the hardware module. The secure key may be used to encrypt data transmitted between the first hardware module and a second hardware module of the portable terminal.

In the secure mode, one or more hardware modules may not be permitted to communicate or interact with each other. However, if the portable terminal is rebooted in a non-secure mode, the one or more modules may then be able to interact with each other. Thus, in this way, during the process of generating a secure key, the number of hardware modules that are operational may be reduced, which may reduce a likelihood of a security compromise from other hardware modules that may not be utilized for the generation of a secure key.

The method for generating and managing the secure key disclosed herein is not limited to the described exemplary embodiments, and may be modified. For example, the portable terminal may receive a text message from the authentication server, and convert data included in the text message, and thereby use the converted data as the secure key. Also, the portable terminal may also receive the secure key from a reference device via a near field communication (NFC).

The secure key may be used to encrypt data transmitted between hardware modules using various schemes. For example, the secure key may be used in a touch IC. For example, the touch IC may encrypt, using the secure key, data input via the touch panel, and may transmit the encrypted input data to a communication module. Here, the touch IC may encrypt coordinate data of the touch panel where a touch event occurs. The secure key may be used to encrypt data transmitted between a USIM and the communication module.

The exemplary embodiments according to the present invention may be recorded in a non-transitory computer-readable media including program instructions to implement various operations embodied by a computer. Further, various aspects of this disclosure may be implemented on a processor (not shown).The media may also include, alone or in combination with the program instructions, data files, data structures, and the like. The media and program instructions may be those specially designed and constructed for the purposes of the present invention, or they may be of the kind well-known and available to those having skill in the computer software arts.

According to the exemplary embodiments of the present invention, it is possible to protect important information inputted by a user. Also, according to the exemplary embodiments of the present invention, it may be possible to reinforce a security of a portable terminal by encrypting data transmitted between various hardware modules of the portable terminal. Also, according to the exemplary embodiments of the present invention, it may be possible to manage one or more encryption keys to encrypt data transmitted between hardware modules of a portable terminal.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A portable terminal, comprising:
a first hardware module to encrypt data using an encryption key;
a communication module to receive the encryption key,
wherein the communication module receives the encryption key if the portable terminal is in a secure mode.

2. The terminal according to claim 1, further comprising:
a second hardware module to receive the data,
wherein the second hardware module decrypts the received data.

3. The terminal according to claim 2, wherein a third hardware module is disabled in the secure mode.

4. The terminal according to claim 1, wherein the first hardware module is removable from the portable terminal.

5. The terminal according to claim 1, wherein the communication module receives the encryption key from an authentication server.

6. The terminal according to claim 1, further comprising:
a booting unit to reboot the portable terminal in the secure mode;
an input unit to receive an input; and
an authentication unit to authenticate a user of the terminal based on the received input,
wherein if the authentication is successful, the first module receives the encryption key.

7. The terminal according to claim 1, wherein the first hardware module is a universal subscriber identity module (USIM).

8. The terminal according to claim 1, wherein the booting unit reboots the portable terminal based on a system image stored in a memory of the portable terminal.

9. The terminal according to claim 8, wherein the system image is stored in a non-writeable portion of the memory.

10. A method for implementing an encryption key on a portable terminal, comprising:
entering a secure mode of the portable terminal;
receiving an encryption key;
forwarding the encryption key to a first hardware module,
wherein the first hardware module encrypts data with the encryption key.

11. The method according to claim 10, further comprising:
sharing data between the first hardware module and a second hardware module,
wherein the second hardware module decrypts data shared with the first hardware module.

12. The method according to claim 11, further comprising disabling a third hardware module in the secure mode.

13. The method according to claim 10, wherein the encryption key is received via a connection established from the portable terminal with an authentication server.

14. The method according to claim 10, wherein the first hardware module is removable from the portable terminal.

15. The method according to claim 10, further comprising:
rebooting the portable terminal in the secure mode;
receiving an input;
authenticating a user based on the received input; and
if the authentication is verified, receiving the encryption key if the portable terminal is in the secure mode.

16. The method according to claim 10, wherein the stored permission information comprises a near field communication (NFC) chip identification (ID) of the second terminal.

17. The method according to claim 10, wherein the first hardware module is a universal subscriber identity module (USIM).

18. A method according to claim 15, wherein the rebooting further comprises storing a system image in a memory of the portable terminal.

19. The method according to claim 10, further comprising receiving a selection of the first hardware module.

20. An apparatus, comprising:
a booting unit to enter into a secure mode;
a first hardware module to receive an encryption key to encrypt data; and
a second hardware module to receive the encrypted data, and the second hardware module being disabled in the secure mode,
wherein the first hardware module receives the encryption at a fixed location of the apparatus.
